(19) United States
(12) Patent Application Publication
(10) Pub. No.: US 2023/0286185 A1
(43) Pub. Date: Sep. 14, 2023

(54) THERMAL RELEASE DEVICE AND METHOD

(71) Applicant: Stardust Holdings, LLC d/b/a/ XTERRA Space, Austin, TX (US)

(72) Inventor: Alex Weston Kuehn, Austin, TX (US)

(21) Appl. No.: 18/133,116

(22) Filed: Apr. 11, 2023

Related U.S. Application Data
(60) Provisional application No. 63/319,367, filed on Mar. 13, 2022.

(51) Int. Cl. B26F 3/08

(52) U.S. Cl. CPC B26F 3/08; B64G 1/645

(57) ABSTRACT

This disclosure relates generally to a release device utilizing at least two load bearing elements joined by a thermally degradable structural adhesive with an integral heating element to cause thermal degradation of the mechanical properties of the adhesive resulting in separation of the elements under load. The apparatus of the invention is particularly useful for spacecraft and other vehicular separation mechanisms.

### CROSS-REFERENCE TO RELATED APPLICATIONS

The present application claims the benefit of U.S. Provisional Application No. 63/319,367, filed Mar. 13, 2022; all of which is incorporated herein by reference.

### FIELD

This disclosure relates generally to a release device utilizing at least two load bearing elements joined by a thermally degradable structural adhesive with an integral heating element to cause thermal degradation of the mechanical properties of the adhesive resulting in separation of the elements under load.

### BACKGROUND

Underwater vehicles, aircraft, launch vehicles and spacecraft have long required specialized release devices for various situations. For example, aircraft require release devices for the release of bombs or fuel tanks, launch vehicles require release devices for separating rocket stages or payloads and spacecraft require release devices for releasing solar arrays or antennas amongst other things.

Many release devices have been utilized over the years but they all have a variety of shortcomings. The paradox of release devices is that they “Must Hold” and “Must Release” at different times. For example, pyrotechnic bolts have been utilized but have the shortcoming of generating large shock forces and debris upon release. Non-pyrotechnic separation nuts have also been utilized but, since the restraining nut in the system is split, the holding strength of the nut is less than that of a traditional nut and bolt connection. Various other systems (e.g., shape memory alloy frangible bolts, shape memory alloy actuators, burn wires, etc.) have been utilized with some success but all suffer from relatively weak load carrying capability when compared to a bonded connection.

Structural engineers often consider a bonded connection to be a superior connection between two structural elements. A well-designed bonded connection can create an assembly as close to a single homogeneous piece of material as is possible with any traditional means of connection. Bonding is superior to a weld in that bonding does not thermally weaken or distort the substrates being joined and it is better than a bolted connection because bonding evenly distributes the transmitted load. Structural bonds of various types have been used for thousands of years and the art of bonding is well understood.

Utilization of a bonded connection between two separable elements is highly desirable in the “Must Hold” case but bonds are traditionally intended to be permanent, and the forces required to separate a bond under standard conditions are an impractical option for a release device.

A key characteristic of many structural adhesives that is often overlooked is their mechanical strength degradation at higher temperatures. When many types of adhesives (e.g., polyepoxides, polyurethanes, cyanoacrylates, methacrylates, polyvinyl acetates, aliphatic resins, etc.) are heated they undergo a glass transition phase where they become plastic and lose much of their strength and or adhesion capability.

Heat applied convectively with a heat gun (e.g. U.S. Pat. No. 3,492,462) is a traditional method to exploit the above mentioned characteristic to weaken and remove structural adhesives in a manufacturing or demolition setting but would not be practical for use as a release mechanism since this method only works in the 30 presence of an atmosphere, is lengthy, requires a constantly moving heat gun, is power inefficient, and often damages the elements that are bonded since the heating of the bond material must be accomplished through the heating of all of the elements that require separation.

The disclosed subject matter helps to avoid these and other problems.

### SUMMARY

This disclosure relates generally to a release device utilizing at least two load bearing elements joined by a structural adhesive with an integral heating element to cause degradation of the mechanical properties of the adhesive to release the elements under load.

The main advantage of using the invention is the provision 15 of a novel means for utilizing a full-strength bonded connection while permitting release of said bonded connection at any desired time.

### DETAILED DESCRIPTION

The inventive device utilizes an adhesive layer as the structural connector (the “Must Hold” state) to hold together at least two elements and a heating element imbedded or directly in contact with the adhesive layer to degrade the adhesive's mechanical properties to permit separation (the “Must Release” 25 state) of at least two elements under load.

The load on the elements may be naturally occurring within the system such as from the weight of the releasable element or may be applied to cause separation once the adhesive is weakened or degraded by any convenient means such as springs, hydraulic 30 cylinders, pneumatic cylinders, etc.

The separable elements may be the primary connecting elements of the system or the separable elements may be connected to additional connecting means such a bolt, screw, or additional permanent bond, etc.

Additionally, the separable elements may be loaded in tension or in shear depending on the application.

At least one heating element is collocated within or adjacent to each adhesive layer and may apply heat directly to the adhesive. The adhesive can also function as an electrical insulator, isolating the heating element electrically from the separable elements.

Additionally, a heating element may be made integral or placed on one or both separable elements if the separable elements are thermally conductive.

The heating element is preferably electrically heated by a resistive heating element but can be heated by any convenient means (e.g., hot fluid pumped through the separable element, an ultrasonic element, frictional element, radio wave or microwave diathermic heating element, chemical reaction element, etc.).

Additionally, an adhesive or plastic which exhibits sufficient elongation behavior when heated rather than separating completely may be used for the bond if the application only requires movement rather than complete separation. This can be utilized in a tension, compression, or shear type layout depending on what is warranted by the application. This can be useful as a trigger mechanism for staged mechanical release mechanisms or for actuators which need to push or pull on an element. This can even allow the device to be reused since the bond can be re-heated after use and pushed or flowed back into place with proper design and material selection.

Additionally, the load bearing elements of the release mechanism can be the primary structure for a separation system such as those used to release satellites with the addition of deployment spring mechanisms to the load bearing elements.

Additionally, for satellite separation applications if a rapid response release is desired, the invention can be paired 5 with a faster more traditional release mechanism in a two-stage configuration where the invention provides the primary load bearing capability during launch, is then released on orbit, and then the second release mechanism can hold the low load of only the separation springs and can be released as fast as desired later 10 in the flight.

Utilization of the combination of an adhesive layer with a heating element in a release device consisting of at least two load bearing elements provides the following advantages: 1. High load holding capabilities in excess of even bolted connections are possible, 2. Controlled separation of the elements when desired by simply applying the proper heat, 3. Very high holding to device mass ratios are achievable, 4. Low profile and uniquely shaped release device geometries can be created, 5. Low release shock may be achieved with proper adhesive selection and device design, 6. Integral construction of the release device in a structure is possible.

Some applications of the release device include submarine torpedo release mechanisms, submarine door release mechanisms, and underwater cable release mechanisms. Some aviation applications are bomb release mechanisms, fuel tank release mechanisms, parachute release mechanisms, and safety device release mechanisms. Some launch vehicle applications include rocket stage separation systems, payload separation systems and landing gear release mechanisms. Some spacecraft applications include solar array release mechanisms and antenna release mechanisms amongst other things. This can also be used as a trigger mechanism release energy stored in staged release mechanisms of various types such as those using compressed gas or spring(s) or more.

### BRIEF DESCRIPTION OF THE DRAWINGS

A more complete understanding of the invention and the many attendant advantages thereof will be readily appreciated as the same becomes better understood by reference to the following detailed description, when considered in connection with the accompanying drawings wherein:

FIG. 1a is a section view of the first embodiment before release.

FIG. 1B is a detail view of the first embodiment before release.

FIG. 1c is a detail view of the first embodiment after release.

FIG. 2a is a cutaway view of the second embodiment before release.

FIG. 2b is a cutaway view of the second embodiment after release.

FIG. 3a is a section view of the third embodiment before release.

FIG. 3b is a section view of the third embodiment after release.

FIG. 4 is a graph showing a typical strength to temperature curve for a typical adhesive used for the invention.

### DESCRIPTION OF THE PREFERRED EMBODIMENT

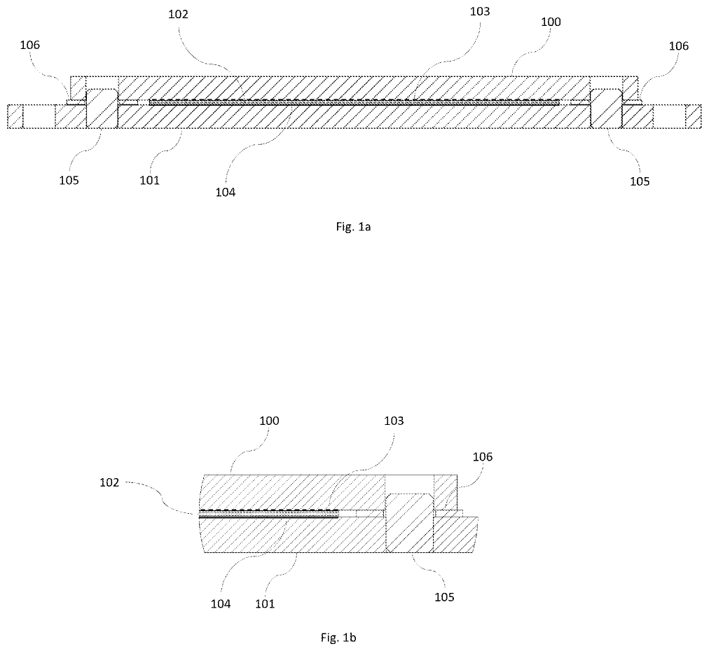

In FIG. 1a the inventive device utilizes two printed circuit boards 100 and 101 joined by adhesive layer 102 in tension mode (the “Must Hold” state). Printed circuit board 100 contains 30 resistive heating element traces 103. Printed circuit board 101 contains solid conductive layer 104. Disc springs 106 are applying a tension preload between printed circuit board 100 and 101. Dowel pins 105 are constraining disc springs 106 and controlling relative location of printed circuit boards 100 and 101 to each other. Holes in printed circuit boards can be utilized to fasten to other elements or printed circuit boards can be bonded directly to other elements.

In FIG. 1b the inventive device utilizes two printed circuit boards 100 and 101 joined by adhesive layer 102 in tension mode (the “Must Hold” state). Printed circuit board 100 contains resistive heating element traces 103. Printed circuit board 101 contains solid conductive layer 104. Disc springs 106 are applying a tension preload between printed circuit board 100 and 101. Dowel pins 105 are constraining disc springs 106 and controlling relative location of printed circuit boards 100 and 101.

In FIG. 1c the resistive heating element traces 103 have been heated by applying electrical current transferring heat flux into and through adhesive layer 102 to conductive layer 104 which reflects and distributes heat flux evenly across adhesive layer 102 to the point of causing the adhesive layer 102 to reduce in tensile strength to permit separation of printed circuit boards 100 and 101 at the intersection of adhesive layer 102 and conductive layer 104 under the tension load applied by disc springs 106 to printed circuit boards 100 and 101 (the “Must Release” state).

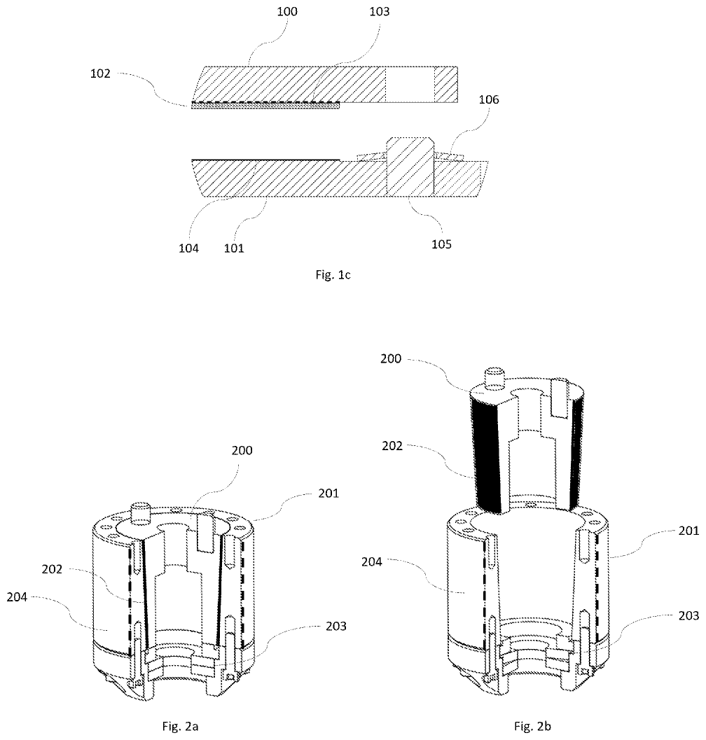

In FIG. 2a the inventive device utilizes resistive film heating element 204 to heat external body 201 and adhesive layer 202 bonding external body 201 and internal body 200 together in shear mode (the “Must Hold” state). Disc springs 203 are providing a shear load between external body 201 and internal body 200. The threaded element in 200 and threaded elements in 201 can be utilized to hold together any other elements by means well known in the arts.

In FIG. 2b the resistive film heating element 204 has been heated by applying electrical current causing external body 201 and adhesive layer 202 to also be heated by direct transfer of heat flux to the to the point of causing adhesive layer 202 to reduce shear strength to permit separation of threaded elements 200 and 201 under shear load applied to elements 200 and 201 (the “Must Release” state) by disc springs 203.

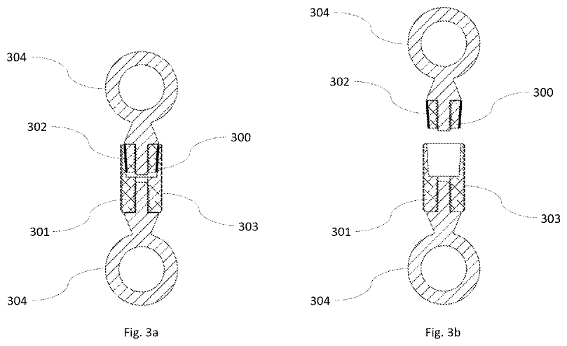

In FIG. 3a the inventive device utilizes resistive film heating element 303 to heat external body 301 and adhesive layer 302 bonding external body 301 and internal body 300 together in shear mode (the “Must Hold” state). Hoist rings 304 provide a means to hang an external mass in a gravity environment or to attach to an external tension load providing a shear load between external body 301 and internal body 300. The threaded element in 300 and threaded element in 301 can be utilized to attach directly to any other elements other than hoist rings 304 by means well known in the arts.

In FIG. 3b the resistive film heating element 303 has been heated by applying electrical current causing external body 301 and adhesive layer 302 to also be heated by direct transfer of heat flux to the to the point of causing adhesive layer 302 to reduce shear strength to permit separation of threaded elements 300 and 301 under shear load applied to elements 300 and 301 (the “Must Release” state) by hoist rings 304 interfacing with an external load.

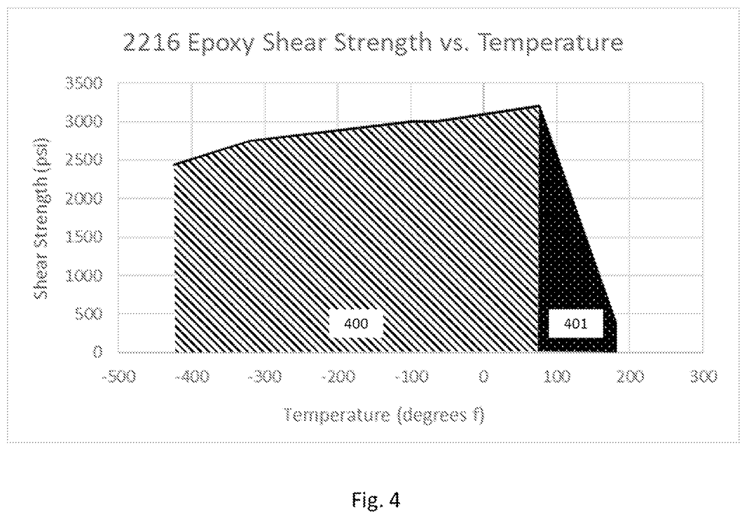

FIG. 4 illustrates the strength to temperature curve for a typical adhesive (e.g., 2216 epoxy). It is apparent that at lower temperatures 400 the adhesive provides maximum strength to perform the “Must Hold” state of the invention but, as the temperature rises by applying heat through any means, preferably concentrated heat flux as in resistive heating elements 103/204/303, the strength of the adhesive is reduced over zone 401 to the point of permitting a relatively small force to separate the connecting elements 100/101 or 200/201 or 300/301.

The invention is preferably electrically actuated via a resistive heating element capable of operating in a liquid, high 5 pressure, low or zero pressure (vacuum) environment but can be of any heating means deemed convenient for the application (e.g., hot fluid pumped through the separable element, an ultrasonic element, frictional element, radio wave or microwave diathermic heating element, chemical reaction element, etc.). The heating means may 10 also consist of a redundant heating system (two or more resistive heating elements connected in series or parallel) to provide increased reliability for the assured separation (the “Must Release” state) of at least two elements 100 and 101/200 and 201/300 and 301.

The inventive device permits the maximum strength of the bonded joint (100 to 101/200 to 201/300 to 301) to be utilized in an evenly distributed manner reducing the need for additional structure and larger quantities of lower performance separation devices. This has the effect of minimizing the total mass required for the holding/release mechanism of the overall system.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A Thermally Actuated Release Device comprising:
a first element,
a second element,
a thermally degradable bond element,
and a thermal source;
where said first element and said second element are connected by said thermally degradable bond element and,
where said thermal source causes said thermally degradable bond element to release connection between said first and second elements.

2. A method of providing a Thermally Actuated Release function, said method comprising:
a connecting means utilizing a thermally degradable bond and, removing said connecting means by heating said thermally degradable bond.
